(19) United States
(12) Patent Application Publication
(10) Pub. No.: US 2003/0112423 A1
(43) Pub. Date: Jun. 19, 2003

(54) On-line verification of an authentication mark applied to products or product packaging

(76) Inventors: Rakesh Vig, Durham, CT (US); Peter Miller, New London, CT (US); Drew Swanson, Brookfield, CT (US)

Correspondence Address: WOLF GREENFIELD & SACKS, PC, FEDERAL RESERVE PLAZA, 600 ATLANTIC AVENUE, BOSTON, MA, 02210-2211, US

(21) Appl. No.: 10/274,456

(22) Filed: Oct. 18, 2002

Related U.S. Application Data
(63) Continuation-in-part of application No. 09/556,280, filed on Apr. 24, 2000.
(60) Provisional application No. 60/353,481, filed on Feb. 1, 2002.

(51) Int. Cl. G06K 9/74

(52) U.S. Cl. 356/71

(57) ABSTRACT

A system and method of verifying application of an authentication mark on a substrate is disclosed. Light-sensitive compounds can be used to identify the product or product packaging. A printer, locatable at the production line, prints at least one light-sensitive compound on the product or product package to produce at least a portion of the authentication mark. A verification device, locatable at the production line, verifies the application of the at least one light-sensitive compound on the product or product package.

### RELATED APPLICATIONS

This application claims the benefit of and is a continuation-in-part of co-pending U.S. patent application Ser. No. 09/556,280, filed Apr. 24, 2000 and also claims the benefit of co-pending U.S. Patent Application Serial No. 60/353,481, filed Feb. 1, 2002.

### FIELD OF THE INVENTION

This invention relates to devices and methods for verifying the application of at least a portion of an authentication mark to products or product packaging.

### BACKGROUND OF THE INVENTION

Brand identity plays an important role in the marketplace. It provides a means for consumers to identify and rely on products coming from a particular source. It also provides a means for companies to attract and build goodwill with customers, thereby encouraging repeat business. Companies therefore spend billions of dollars on advertising and product development to establish such brand identity.

The benefits of and the resources expended on brand identity create powerful incentives for counterfeiters. Among the most prevalent illicit and illegal practices threatening brand identity are counterfeiting of the product itself, counterfeiting or theft of the package or container for use with an authentic or counterfeit product, or diversion of the product wherein the product manufactured for sale in a certain market is purchased by an intermediary in that designated market and sold in a competing market.

Such practices result in significant damage to the owner of the brand including lost sales, tarnished consumer perception of the brand, and liability due to claims made on counterfeit products. For example, the International Anti-Counterfeiting Coalition estimates that global revenue lost due to counterfeiting is as high as $200 billion per year. In addition, labeling industry estimates suggest that counterfeiting accounts for more than 10% of the world trade. Finally, pharmaceutical companies estimate that they are losing approximately $500 million in lost sales in India alone due to imitation drugs.

In addition to injury to brand identity, rights to copyrighted works may also be compromised by unauthorized reproduction of copyrighted material.

Commonly assigned U.S. Pat. No. 5,753,511 and U.S. patent Ser. No. 09/232,324, both of which are herein incorporated by reference in their entireties, disclose automated methods of evaluating and discriminating products to establish authenticity or point of origin of the product. Aspects of these inventions relate to automated methods for identifying key ingredients and/or the relative amounts of key ingredients in products using light-sensitive compounds. In particular, during testing, an identifying light-sensitive compound is mixed with a small amount of the sample to be tested. The sample, having the particular light-sensitive compound, is then brought into close proximity with and viewed using a custom optical scanner to detect light emission of a particular wavelength from the sample.

One advantage of the test procedure disclosed in the '511 patent and the '324 application is that the sample to be authenticated is mixed with a particular light-sensitive compound immediately prior to testing. This allows for the product to remain unadulterated for consumption yet allows for the interaction of the particular light-sensitive compound with key ingredients in the product to establish a fingerprint for the product.

In some instances, however, it may be desirable to permanently mark the product or the package with an identifying or authenticating mark. Such identification allows, for example, detecting whether the product itself is authentic, when and where the product was produced, whether the product package is authentic or whether the product package relates to the product. Known methods of permanent marking include the use of invisible inks, holograms or other identifying marks placed on the product or product package. However, some of these techniques may not be practical in ambient light conditions, and therefore cannot be practiced in lighted areas such as retail stores. Another method includes printing the product or package with an ink containing an infrared absorbing additive. A scanner is used to detect infrared absorbence, thereby indicating the presence of the additive. This method suffers from a number of disadvantages. For example, identification of product specific information is not possible. Rather, only discrimination between a product or package containing the additive and a product or package lacking the additive is possible. Thus, discriminating between different products, manufacturing locations, or other desired information is not possible. In addition, the scanner used to read the ink is a dedicated scanner and is not capable of reading other information such as a bar code.

The disadvantages of the above noted methods are overcome in commonly assigned U.S. patent application Ser. No. 09/556,280, which is hereby incorporated herein by reference in its entirety. For example, one or more light-sensitive compound is mixed with ink and printed on the product or the product package during or after manufacture of the product to create at least a portion of an identifier or authentication mark that is capable of providing multiple pieces of information and that is undetectable with conventional lights and optical scanners. The authenticity of the product or package may be subsequently quickly determined. In some instances, the authenticity mark may be the bar code on the package. In this regard, the authentication device may be used to quickly scan the bar code to identify the product as well as to verify the authenticity of the product and/or package. Authenticity of the product package may then be linked to the authenticity of the product itself. Thus, not only may counterfeit products or packages be detected but also diversion of authentic products may be readily determined.

### SUMMARY OF THE INVENTION

In one embodiment, a system for applying at least a portion of an authentication mark to a substrate and verifying the application of at least a portion of the mark on the substrate is provided. The substrate is disposed on a production line. The system comprises an applicator locatable at the production line and configured and arranged to apply at least one light-sensitive compound on the substrate to produce at least a portion of the authentication mark; and a verification device locatable at the production line and configured and arranged to verify application of the at least one light-sensitive compound on the substrate.

In another embodiment, a method of applying at least a portion of an authentication mark to a substrate and verifying the application of at least the portion of the mark is disclosed. The substrate is disposed on a production line. The method comprises applying at least one light-sensitive compound on the substrate to produce at least the portion of the authentication mark, with the application occurring as the substrate proceeds through the production line, and verifying application of the at least one light-sensitive compound on the substrate as the substrate proceeds through the production line.

In yet another embodiment, a system for applying at least a portion of an authentication mark to a substrate and verifying the application of at least the portion the mark on the substrate is provided. The substrate is disposed on a production line. The system comprises a printer locatable at the production line and configured and arranged to print at least one light-sensitive compound on the substrate to produce at least a portion of the authentication mark and a verification device locatable at the production line and configured and arranged to verify application of the at least one light-sensitive compound on the substrate. The verification device comprises a frame and a light source mounted to the frame. The light source is adapted to emit light having a predetermined wavelength to irradiate the at least one light-sensitive compound and the substrate. An excitation filter is mounted to the frame and cooperates with the light source to filter an undesired wavelength of light emitting from the light source. The frame and at least one of the light source and the excitation filter are constructed and arranged such that at least one of the light source and the excitation filter is removable from the frame by a user thereby allowing the user to employ at least one of a different light source capable of emitting light having a different predetermined wavelength of light and a different excitation filter capable of filtering a different undesired wavelength of light emitting from the light source. The verification device also includes a detector adapted to detect at least a first light response from the at least one light-sensitive compound and a controller for comparing at least the first light response to a fingerprint.

Various embodiments of the present invention provide certain advantages and overcome certain drawbacks of prior methods. Embodiments of the invention may not share the same advantages, and those that do may not share them under all circumstances. This being said, the present invention provides numerous advantages including the noted advantage of on-line verification of the application of at least a portion of the authentication code to the product or product packaging.

Further features and advantages of the present invention, as well as the structure of various embodiments, are described in detail below with reference to the accompanying drawings.

### BRIEF DESCRIPTION OF THE DRAWINGS

The invention will now be described, by way of example, with reference to the accompanying drawings, in which:

FIG. 1 is a schematic representation of a production line including an verification device;

FIG. 2 is a process diagram according to an aspect of the invention;

FIG. 3 is a schematic representation of one embodiment of the verification device shown in FIG. 1;

FIG. 4 is a graph representing selection of light-sensitive compounds;

FIGS. 5-8 represent chemical structures of various light sensitive compounds; and

FIG. 9 is a graph representing light emission of two light-sensitive compounds.

### DETAILED DESCRIPTION

The invention is directed to applying at least a portion of an authentication mark on a product or product packaging and verifying the application of at least the portion authentication marks by analyzing key ingredients in the mark. Light-sensitive compounds can be used to identify the product or product packaging. In one aspect, the product or product package may include an authentication mark, such as a bar code or other identifier, comprising one or more light-sensitive compounds. The entire mark or portions thereof, may be applied in one or more locations on the product or product packaging as the product or package moves along a production line. The mark may be visible or invisible to the naked eye and may include a visible or invisible ink. A sealer may be applied over the mark or mixed with the mark to inhibit removal of the authentication mark from the product or product package, thereby creating a tamper-resistant mark, as described in co-pending commonly assigned U.S. patent application Ser. No. 10/212,334, which is hereby incorporated herein in its entirety. A device to verify application of the light-sensitive compound(s) employed in the mark or portion thereof may be situated on or near the production line. The device may include a source of light to irradiate light-sensitive compound(s), one or more optical detectors to detect a light response or a sample characteristic from the light-sensitive compound(s), and a controller to verify the application of the light-sensitive compound(s) to the product or product package by comparing the emitted or absorbed properties to a standard. The controller may induce an action such that if the measured properties are the same as the standard, the product or product package may continue along the production line for further handling, e.g., packaging or shipping. If the comparison is not satisfactory, the product or product package may be removed from the production line or another action may occur. Application and verification of the mark may be useful in a variety of fields including manual or automated conveyor based print lines, inventory control, distribution control and product authentication.

Light-emissive compounds emit light in response to irradiation with light. Light emission can be a result of phosphorescence, chemiluminescence, or, more preferably, fluorescence. Specifically, the term “light-emissive compounds”, as used herein, means compounds that have one or more of the following properties: 1) they are a fluorescent, phosphorescent, or luminescent; 2) react, or interact, with components of the sample or the standard or both to yield at least one fluorescent, phosphorescent, or luminescent compound; or 3) react, or interact, with at least one fluorescent, phosphorescent, or luminescent compound in the sample product, the standard, or both to alter emission at the emission wavelength.

Light-absorbing compounds absorb light in response to irradiation with light. Light absorption can be the result of any chemical reaction known to those of skill in the art. Thus, the present invention may be discussed below with reference to emission of light in response to irradiation with light, however, the present invention is not limited in this respect and light absorbing compounds may be used.

Thus, as used herein, the term “light-sensitive compounds” refers to both light emissive compounds as well as light absorbing compounds.

The term “fingerprint”, as used herein, means light emission or absorption intensity and/or intensity decay at a particular wavelength or range of wavelengths, from one or more light-sensitive compounds in combination with a standard (e.g., authentic) product or product package. Accordingly, each product or product package can have a particular fingerprint.

The term “authentic”, or any derivative thereof, means an identification as being genuine or without adulteration or identification of point of origin or other desired information.

The term “fingerprint profile”, as used herein, means an assembly of fingerprints of a standard in combination with a series (or profile) of different light-sensitive compounds.

The term “sample characteristic” or “light response”, as used herein, refers to the light emission or absorption quantity or intensity and/or intensity decay or change in quantity from one or more light-sensitive compounds on a sample product or product package.

The term “substrate” refers to any surface onto which a light-sensitive compound may be applied.

The term “invisible” means invisible to the naked eye.

The term “readable image” is an image that conveys information when read by a human or a machine. Examples include, but are not limited to, numbers, letters, words, logos, and bar codes.

The “visible” range is 400-700 nm.

The “UV” range is 40-400 nm.

The “IR” range is 700-2400 nm.

The “near IR” range is 650-1100 nm.

As described briefly above, the system and method is employed to apply and verify at least a portion of an authentication mark on a product or product package while the product or product package moves through a production line. In one embodiment, the system includes a printer configured and arranged to print at least one light-sensitive compound to produce at least a portion of an authentication mark on a substrate and a verification device configured and arranged to verify the application of the light-sensitive compound in the mark or otherwise on the substrate. Both the printer and the verification device are locatable at a production line.

In some embodiments, the light-sensitive compound and the resulting portion of the authentication mark may be invisible to the naked eye. Thus, it may be desirable to determine whether or not the light-sensitive compound has been properly applied to the substrate. In this respect, it may be important to determine first whether the light-sensitive compound has been applied to the substrate at all and second whether the correct type and quantity of light-sensitive compound was used.

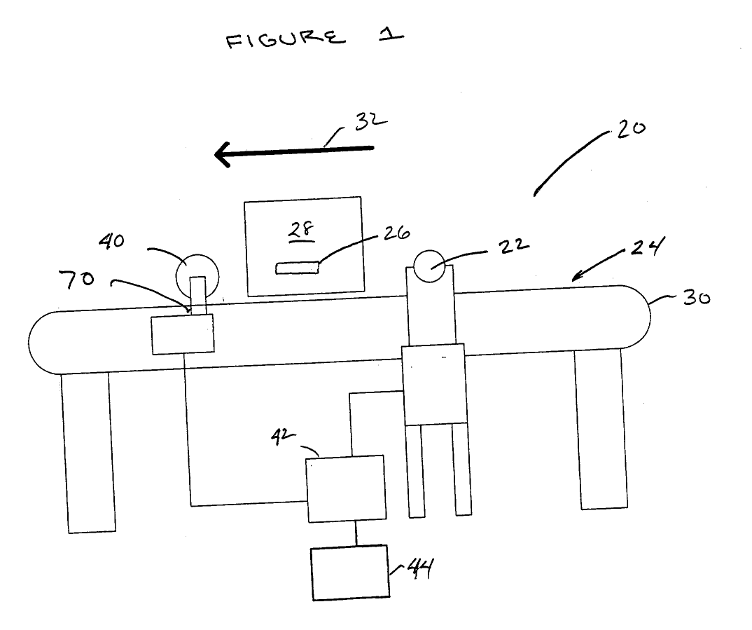

As shown in FIG. 1, one embodiment of the system for applying at least a portion of the authentication mark to a substrate and verifying the application of at least a portion of the mark is shown. The system 20 includes a printer 22 locatable at a production line 24. The printer 22 is configured and arranged to print at least a portion of the authentication mark 26 on a substrate 28. The substrate 28 may be a product or a product package and is positioned on the production line 24, which may include a conveyor belt 30, such that the substrate is able to move downline along direction line 32. As discussed above, the printer prints at least one light-sensitive compound onto the substrate to form at least a portion of the authentication mark.

To determine whether the light-sensitive compound has been applied and whether it is the desired light-sensitive compound and/or in the desired amount, the system 20 further includes a verification device 40 located downline of the printer 22. The system may further include a controller 42 that communicates with the printer 22 and the verification device 40. The controller may be used to compare the sample characteristic or light response (which may be light emitted or absorbed by the light-sensitive compound) to a standard, such as a fingerprint or fingerprint profile. If the light response is present, then it is assumed that the substrate included the light-sensitive compound. If the light response compares favorably to the standard, then it is assumed that the correct light-sensitive compound was applied and that the correct quantity was applied. The verification device may take sample readings from a one or more locations on the mark and/or substrate and from these readings, compute a level of confidence. If the level of confidence is great enough, then the mark is verified.

In addition, the controller may be used to automatically take appropriate corrective action should the authentication mark be deemed to be not verified. The controller 42 may signal the printer 22 to stop printing so that the application of the authentication mark to the substrate may be corrected. In addition, the controller 42 may communicate with the printer 22 so that the printer can adjust the amount of or type of light-sensitive compound applied to the substrate. Further, the printer 22 may receive signals from the controller 42 to adjust the location or information that is printed on the substrate.

The system may also include an indicator 44 that communicates with the verification device 40 and, if desired, printer 22, directly or via controller 42. The indicator may be used to indicate to a user whether the authentication mark is verified. In one embodiment, the indicator provides a red or green light indicating non-verified or verified, respectively. Of course, an audible signal may be employed instead of or in addition to the visual signal.

The controller 42 may also communicate with a production line controller (not shown), or itself may be part of the production line controller. In this respect, should the verification device indicate that the authentication mark is not verified, than the production line controller would take an appropriate action regarding the further handling of the substrate. In this respect, if the substrate is indicated as having a faulty authentication mark, then the production line controller may direct the conveyor 30 to distribute the substrate to an area such that it not be shipped or shipped to a different area than what was originally designated. For example, a non-verified substrate can move to an alternative production line, which may be trash chute or, alternatively a secondary line, where the mark may be removed and the substrate sent back to the beginning of the main production line to be reprinted. Either the controller 42 or the plant controller may be user programmable such that when an indication that the authentication mark is not correct or not properly applied, the user may direct the substrate to a certain disposition depending upon user desired outcome.

The verification device is disposed on the production line at a distance from the substrate to allow the substrate to be verified without significant impact from the surrounding area, such as unintended influences from ambient light. In one embodiment, the verification device contacts the substrate. In another embodiment, the verification device is positioned about 12 mm from the substrate, although a greater or lesser distance may be employed, as the present invention is not limited in this respect. In another embodiment, the verification device may be a hand held device such that a production line worker may hold the verification device and manually scan each substrate.

In some instances, it may be desirable to read additional information from the substrate using the verification device. For example, it may be desirable to read a design, logo, pattern, or other information contained in the mark or on the substrate. Thus, in one embodiment, the verification device can be a relatively simple device in which the presence or absence of the light-sensitive compound is determine; in another embodiment, the verification device can verify product information such as the date, time, source or location of manufacturing, the intended distribution channel, or any other desired information. This may be accomplished by distinguishing between a plurality of light-sensitive compounds that could be employed on the substrate, with each light-sensitive compound providing a particular piece of information. Further, software may be employed in the verification device or associated controller so that the device can read information using suitable techniques, such as optical or pattern recognition techniques. The verification device may also verify the size and shape of the mark as well as the type of light-sensitive compound used in the mark.

As shown in FIG. 1, the verification device 40 is located down line of the printer 22. The distance separating the printer and the verification device is not critical, as the light-emissive compound need not be dry before being verified, if a liquid light-sensitive compound is employed.

Further, as mentioned above, the mark may be rendered tamper-resistant through the use of a UV curable overcoat on the light-sensitive compound. The UV cure station (not shown) may be located before or after the verification device. In one embodiment, the UV cure station is located before the verification device, but in some instances it may be preferable to place the UV cure station after the verification device. For example, if a removable light-sensitive compound is applied to the substrate and it determined not to be verified, the light-sensitive compound or the entire mark may be removed, thereby returning the substrate to be reprinted. In this case, it would be preferable not to render the light-sensitive compound tamper-resistant until it has been verified.

In some instances, it may be desirable to employ a verification device that can be modified to verify a variety of different light-sensitive compounds and substrates. Depending on the light-sensitive compound(s) as well as the desired degree of verification, the verification device can be modified by varying the components employed. In one embodiment, the light source, filters, lenses, and/or discrimination software, for example, may be removed from the verification device and replaced with components suitable to verify the chosen light-sensitive compound. Further, components of the verification device may be electronically changed. For example, the verification device may include programmable components and a programmable computer that adjusts the components to detect the response from the desired light-sensitive compound.

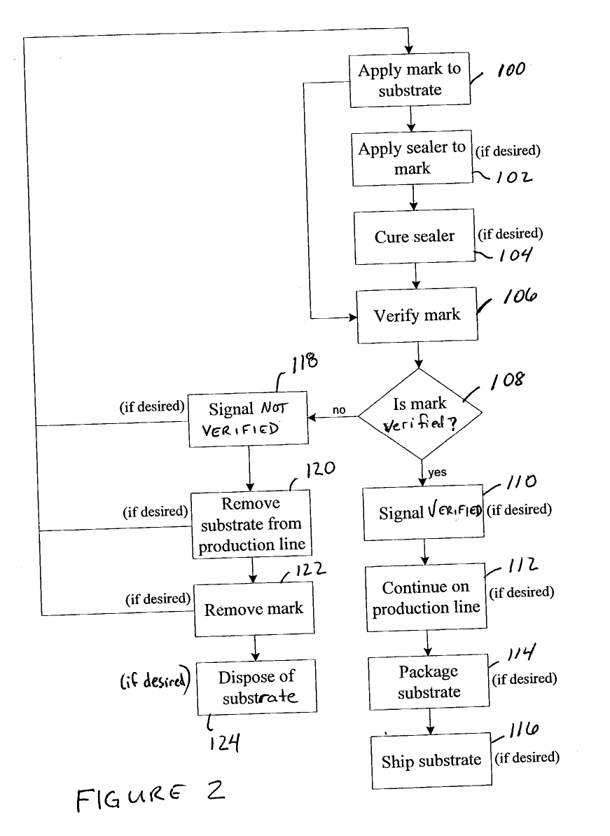

An exemplary process for verifying the application of a mark on a substrate will now be described with reference to FIG. 2. At block 100, the mark containing the one or more light-sensitive compounds is applied to the substrate using any of the techniques described herein or that is otherwise suitable. Next, at block 102, a sealer may be applied, if desired, and at block 104, the sealer is cured, if a curable sealer is used. In this manner, the mark may be rendered tamper-resistant as described herein. At block 106, the mark is verified and at block 108, it is determined whether the mark is verified, as described herein. If the mark is verified as being correct, at block 110, a signal may be given, if desired, to indicate as such. At block 112, the substrate continues on the production line for further handling, such as packaging, if desired (block 114) and/or shipping, if desired (block 116).

Continuing with reference to FIG. 2, if at block 108 it is determined that the mark is not verified, then at block 118, a signal may be given, if desired, to indicate as such. As discussed herein, the substrate may then be redirected to apply the mark to the substrate, as shown at block 100. Alternatively, as described herein, if desired, the substrate may be removed from the production line, as shown at block 120. The substrate may then proceed to have the mark applied, as shown at step 100, or if the mark was incorrect, for example, at block 122, the faulty mark may be removed from the substrate. At block 124, if desired, the substrate may be disposed of. It should be appreciated that the foregoing processes are exemplary only and are not intended to be limiting. Thus, any suitable combination of the processes described with reference to FIG. 2 may be performed, as the present invention is not limited in this respect.

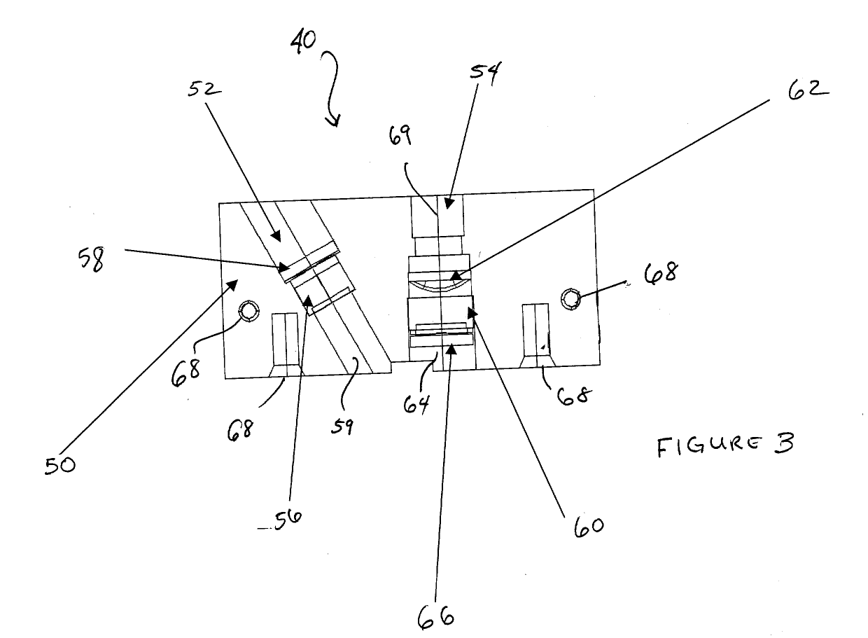

It should be appreciated that any suitable verification device may be employed, as the present invention is not limited in this respect. As shown in FIG. 3, which is a schematic representation of one embodiment of a verification device, in its simplest form, the verification device 40 includes an optical block or frame 50, a light source 52, and a detector 54. As described above, the light source emits light having, but not necessarily limited to, a predetermined wavelength. Light from the light source acts on the light-sensitive compound(s) on the substrate and light emitted or absorbed (e.g., a light response) by the light-sensitive compound is detected by the detector 54. Although only one light source is shown, the present invention is not limited in this respect, as more that one (e.g., two) light sources may be employed. The light source may be a steady burn, strobe or flash, depending upon the type of light-sensitive compound used. In this respect, a persistent light-sensitive compound, such as a phosphorescent compound, may emit light after the irradiating light is gone.

The light source 52 may be a light-emitting diode, which may or may not be infrared light-emitting diodes or near infrared light-emitting diodes. In an alternative embodiment, the light source may be a laser light source. In either case, the light source produces light having an excitation wavelength of one or more light-sensitive compounds in the mark on the product or product packaging.

The verification device 40 may also include an excitation filter 56, such as a bandpass or cutoff filter, to filter an undesired wavelength of light emitting from the light source. Thus, in one embodiment, the excitation filter 56 is disposed along the line of light emitting from the light source 52. A suitable excitation lens 58 may also be employed to focus the light from the light source. The lens 58 may be located between the light source 52 and excitation filter 56 or may be located after the excitation filter 56 along the line of light exiting the verification device. Light exiting the device may pass through exit port 59.

The verification device 40 may similarly include an emission filter 60, such as a bandpass or cutoff filter, to filter an undesired wavelength of light emitted from the light-sensitive compound or substrate. Thus, in one embodiment, the emission filter 60 is disposed along the line of light emitting from the light-sensitive compound toward the detector. A suitable emission lens 62 may also be employed to focus the light from the light-sensitive compound. The lens 62 may be located between the light source 52 and excitation filter 56 or may be located before the excitation filter 56 along the line of light entering the verification device. Light entering the device may pass through entrance port 64 before being detected by the detector 54. The detector 54 may be any suitable detector, as the present invention is not limited in this respect. One example of a suitable detector is a charge couple device (CCD). Other suitable detectors, such as a CMOS or PMT, may be employed. The line of sight of the detector may be straight on such that the plane of the substrate is perpendicular to the axis 69 of the detector. Alternatively, the line of sight may be at a non-perpendicular angle relative to the plane of the substrate. The device 40 may also include an objective lens 66 located to focus light entering the verification device.

Other components employed by the verification device that are not shown include, but not necessarily limited to, a power source and cords, controllers and signal lines.

As mentioned above, it may be desirable to change the various components of the device to tune the device to a selected light-sensitive compound. Thus, in one embodiment, any single or combination of lenses, filters and light source(s) may be removed from the frame so that a user may select a component having a characteristic suitable for the chosen light-sensitive compound. In particular, the frame and any of the light source(s), filters and lenses is configured to allow the component to be removed from the frame. Any suitable mechanism for allowing the component to be removed may be employed, as the present invention is not limited in this respect. For example, the frame may include a suitable slot to allow the lens or filter or light source(s) to drop into or otherwise mount to the frame. A suitable locking device may be employed to hold the component to the frame.

The frame 50 may include mounting holes so that the device 40 can be positioned on a suitable stand 70 or the like to place the device in a suitable position relative to the production line, as shown in FIG. 1.

In another embodiment, the verification device is a wand, as described in commonly assigned co-pending U.S. Patent No. 60/353,481, which is hereby incorporated herein by reference in its entirety. The wand may comprise the same or similar components as those described with reference to FIG. 3. In particular, the wand may include an excitation light source(s), filters, and lenses. The wand may be moved across the substrate to be verified, or may be stationary, as desired. The excitation light source may excite the light-sensitive compound(s) of the authentication mark to produce a response. The excitation light source may be either a coherent source, such as, but not limited to, a light-emitting diode (LED), or an incoherent source, such as, but not limited to, a laser diode (LD). Filters may also be employed to filter undesired wavelengths of either excitation light, emission light or both. A detector is employed to detect light response from the light-sensitive compound, and may comprise, without limitation, a silicone photodiode. An indicator may be employed to indicate that the light-sensitive compound is verified or incorrectly applied.

In another embodiment, the verification device may be constructed as a hand-held probe, such as described with reference to FIGS. 1 and 2 in commonly assigned co-pending U.S. patent application Ser. No. 09/556,280, which is hereby incorporated herein by reference in its entirety. The device may include similar components as described above with reference to FIG. 3. Briefly, in the FIGS. 1 and 2 embodiment of the '280 application, the verification device includes a hand-held probe assembly having a probe body, which may be a unitary body or may be formed with a plurality of discrete body parts. The probe body includes one or more light sources disposed therein. In a preferred embodiment, the light sources are provided by light-emitting diodes such as Model Number HLMP CB15 sold by Hewlett-Packard, California, USA, which may or may not be infrared light-emitting diodes or near infrared light-emitting diodes. In an alternative embodiment, the light source may be a laser light source. In either case, the light source emits light having an excitation wavelength of one or more light-sensitive compounds in the mark on the product or product packaging. The probe assembly may further include source filters, such as bandpass or cutoff filters, to isolate wavelengths of light from the light source. Lenses, such as symmetric convex lenses each having a 10 mm focal length with a 10 mm diameter, focus light emitted from the light sources and also focus light onto a detector. One or more prisms (not shown) may also be used to direct or focus light. One example of a detector is a charge couple device (CCD) Model Number H53308 sold by EdmundScientific, New Jersey, USA. Other suitable detectors, such as a CMOS or PMT, may be employed. An emission filter, such as a bandpass or cutoff filter (or light absorption), is used to isolate excitation wavelengths from emission spectra due to light emission from the mark. A controller, such as a PALM PILOT®, may communicate with the probe assembly to compare the light response to a fingerprint.

In yet another alternative, the verification device may be constructed as a camera described with respect to FIGS. 15-19 of the above-mentioned co-pending U.S. Pat. application Ser. No. 09/556,280. Briefly, in the FIGS. 15-19 embodiment of the '280 application, the device includes components similar to those described above as well as a processor, such as a Fujitsu Teampad, coupled to an image capture system. The image capture system includes a signal processor, such as a digital signal processor (DSP), two detectors, such as that described above, and a flash control system, such as light source. One DSP that may be used is model 320C52 from Texas Instruments, Dallas, Tex. The processor also provides a number of functions such as providing a user interface, which may include a display. The processor also accepts the images from the DSP, processes the images to distinguish the background from the fluorescent image, and colors the image in pseudo-colors to enable the user to distinguish the background from the fluorescent image. The processor may employ a Windows 95 operating system, although other suitable operating systems may be employed. The excitation light source may be of any intensity and may last for any duration. Preferably, the light source is of a high intensity to increase the intensity of the emission wavelengths from the light-sensitive compounds so that the emission (or absorption) wavelengths can be resolved from background emission (or absorption). This may also allow for detection from more than 6 inches away. In this embodiment, the excitation light source is of sufficient intensity so that the resulting spectra may be measured at a distance, for example, up to 12 feet, without the need to compensate for background emission. In one embodiment, the spectra may be detected as a distance of up to four feet. In another embodiment, the spectra may be detected as a distance of up to six feet.

It is to be appreciated that any suitable device may be employed to verify the authentication mark (i.e. detect emitted or absorbed light from the authentication mark), as the present invention is not limited in this respect. Thus, the particular devices described herein are exemplary only and not limiting. Detection of light absorbed from the light-absorbing compounds may be made using any suitable imaging technique. Similarly, detection of light emitted from the light-sensitive compounds may be made using any suitable imaging technique such as infrared, near infrared, far infrared, Fourier transformed infrared, Raman spectroscopy, time resolved fluorescence, fluorescence, luminescence, phosphorescence and visible light imaging. The controller or processor and associated software receives and manipulates information from the optical detector and converts it into a sample characteristic, which may then be compared with a fingerprint or fingerprint profile stored in the controller or processor or stored in a remote host computer and associated database. In the latter embodiment, the controller or processor communicates with a host computer via a data cable through, for example, a modem. Of course, other communication links may be used, such as a direct data link, satellite transmission, coaxial cable transmission, fiber optic transmission or cellular or digital communication. The communication link may be a direct line or through the Internet. The host computer also communicates with a database which stores a plurality of fingerprints or fingerprint profiles.

As discussed above, the system may also include a suitable applicator to apply at least the portion of the mark having the light-sensitive compound(s) to the product or product package. In one embodiment, the applicator is a printer. Any type of printer can be used, such as a multi-color printing press, an ink jet printer, a dot matrix printer, silk screening or pad printing, as the present invention is not limited in this respect. Alternatively, the mark may be first applied to a decal or adhesive label, which is in turn applied to the substrate. Additionally, the mark may be sprayed on using, for example, an airbrush, an air gun or an aerosol-type spray.

In one embodiment, the printer prints one or more light-sensitive compound(s) mixed with an ink, which may or may not include a suitable solvent, to form at least a portion of the mark. Preferably, one or two light-sensitive compounds are used to create the mark but it is to be appreciated that any number of compounds can be used. The ink and/or light-sensitive compounds may be a visible ink or a invisible ink and in one embodiment is water insoluble. In one embodiment, a first light-sensitive compound may be mixed with a first ink. In addition, a second light-sensitive compound may be mixed with a second ink and the combination of these two inks may be used to form at least a portion of the mark.

In one embodiment, an ink jet printer is used. Using an ink jet printer may be advantageous because reservoirs having different light-sensitive compounds may be readily changed, for example, through a suitable communication link, depending upon the product, customer, date and/or place of manufacture or any other desired data. In addition, ink jet printers are commonly used to print the bar code on a label or directly on the product or package itself. It is to be appreciated that the authenticating mark may be configured to any desired pattern ranging from a single dot that may convey no more information than what is contained in the ink formulation (i.e., mixed with the light-sensitive compound) to a bar code to a more complex pattern or alphanumeric code that may convey information related to, for example, product, date, time, location, production line, customer, etc.

In one embodiment, a continuous ink jet printer is employed. Using a continuous ink jet printer may offer some advantages, such as the ability to print the mark while the production line and the substrate is moving. Thus, as product comes off the line, the authentication mark can be applied to each product package at a speed commensurate with the line speed of the production line. Of course, whether a continuous ink jet printer is used or not, the substrate may temporarily stop at a location adjacent the printer to allow the mark to be printed thereon.

Further, using a continuous ink jet printer allows the authentication mark to be applied to the substrate when the substrate (e.g., the product packaging), includes the product. That is, when the product is already contained in the product packaging, it may not be feasible to utilize other printing techniques, such as silk screening. For example, silk screening tends to require high temperatures in order to apply indicia. Such high temperatures may have an adverse effect on the product contained within the packaging. In addition, applying the mark after the product is contained within the product packaging may be desirable for distribution purposes. That is, often times, products are made at a single product manufacturing plant but are designated for different channels of trade. A manufacturer may take a batch of product and print it or the package with the authentication mark of the present invention in order to designate that product for a specific market.

An authenticating mark of the present invention may be applied anywhere to a product or product package including on a package flap or inside the package itself. It may be preferable for the authenticating mark to overlap another printed portion on the product or product package. Such printed portions may include those items that are particularly important to the sale of the product, for example, product name, trademark, logo, and company name. In one preferred embodiment, the authenticating mark is placed on the same location on the package as is the trademark of the product. In this manner, any attempt to remove the authenticating mark would also result in the destruction of the trademark on the package. The authenticating mark may be applied to the package as part of the ink formulation used to print the trademark itself or alternatively may be applied either under or over the printing of the trademark. Not only does this placement make it more difficult for the authenticating mark to be removed, but it also provides an easy-to-locate target when checking to verify the presence of the authenticating mark.

As described above, it may be desirable to inhibit removal of the authentication mark. In this manner, the mark may be made tamper-resistant. Exemplary techniques that render a mark tamper-resistant are described in the above-referenced U.S. patent application Ser. No. 10/212,334. In one example, a sealer employed to render the mark tamper-resistant is mixed with the ink and the light-sensitive compound and is therefore printed onto the substrate as the mark, or portion thereof, is being formed.

Further, it should be appreciated that the present invention is not intended to be limited by the substrate to which the mark may be applied. Any product or product package may be marked using this system. Examples of such products are caps (e.g. bottle caps), labels, paper, cardboard, glass, metal, plastics, rubber, bottles, cigarette packages, optical disks, such as CD's or DVD's (as described in commonly assigned co-pending U.S. patent application Ser. Nos. 09/608,886 and 09/631,585, each of which is hereby incorporated by reference in their entireties), jewelry, bank or credit cards, sports memorabilia, auto components or body parts, artistic prints, etc., as the present invention is not limited in this respect.

In one embodiment, the product packaging can be a plastic substrate, such as a container or bottle for a liquid product, such as shampoo, creams and the like. Such plastic materials may include high density polyethylene (HDPE), low density polyethylene (LDPE), polyethylene (PE), polypropylene, polycarbonate, and PETE. Other suitable substrates may be employed, such as metal, including tin and aluminum. Of course, it should be appreciated that the present invention is not limited in this respect and other suitable substrates may be employed.

In order to authenticate copyrighted material, an authenticating mark may be printed directly onto a writing, sculpture, or other piece of artwork. For example, a portion of a book cover may be overprinted with an authenticating mark that is invisible, or not apparent, to the naked eye. If a counterfeiter were to then attempt to duplicate the book cover, for example, by photocopying, the authenticating mark would not be reproduced and a subsequent analysis would reveal that the book cover was not authentic.

Another example is to use the mark of the invention to identify personal property. For example, the mark of the present invention could be applied to a particular portion of a piece of personal property. The mark that would be unique to the owner of the property. If the property is then lost or stolen and later recovered, it may be identified by the uniqueness of the mark as well as by any other information provided by the mark. The mark may also be unnoticeable to a thief, and therefore no effort would be made to remove the identifying mark.

It should be appreciated that the present invention is not limited to the use of a printing process. For example, a fiber of a product may be dipped into a light-sensitive compound and then woven into the material for use in clothing, luggage, book covers, carpeting, currency, prints or other artwork, and the like, such that when the material is exposed to a certain wavelength of light, the light-sensitive compound dipped fiber, would emit or absorb a wavelength of light.

If the product does not lend itself to printing directly thereon, other methods of identifying and authenticating the product may be used. For example, the method described in the '324 application may be used.

An example of a formulation of a printable ink containing one or more light-sensitive compound will now be described. Light-sensitive compounds may be dissolved in methyl-ethyl-ketone (MEK) and added to the ink. In one example, 19 mg of one or more light-sensitive compounds is dissolved in 1 ml of MEK, hereafter identified as Stock I. In another example, 40 mg of one or more light-sensitive compound is dissolved in a 1 ml of MEK, hereafter identified as Stock II. One formulation of visible ink includes 650 g of black ink (such as Black ink #601 produced by the Willett Corporation of England) mixed with 3.5 ml of Stock I, which is designated as Formulation 1. To produce an ink capable of producing two peak wavelengths of light when irradiated (the use of which will be discussed hereinafter), 400 g of Formulation 1 may be mixed with 2 ml of Stock II. Additional compounds may be added to the ink to improve its properties. These compounds may include one or more of the following: a binder; a humectant; one or more lower alcohols; a corrosion inhibitor; a biocide; and a compound used to electrostatically stabilize particles of a colloid suspension. Any number of light-sensitive compounds may be added at a variety of concentrations. For example, a concentration of 1.275 mM has been found to provide an adequate response for some light-sensitive compounds. To facilitate printing, the stock solution or the ink may be filtered, for example, through a 2.0 micron filter to remove large particles. If an ink jet printer is used, it may be preferable to enlarge a standard-sized orifice on the ink jet cartridge so that the ink composition may be more easily applied.

The particular light-sensitive compound selected should have minimal impact on the visible characteristics of the ink so as not to be noticeably different than other printing on the package. For example, one or more light-sensitive compounds mixed with visible ink (such as black ink) is used to print information on the product package, such as the bar code. Alternatively, as mentioned, the authentication mark may be formed as an invisible authentication mark.

A wide variety of light-sensitive compounds may be used with the present invention including any compounds that emit or are excited by light having a wavelength of about 300-2400 nm, and in one embodiment, 300-1100 nm. Groups from which the light-sensitive compounds may be chosen include, but are not limited to, inorganic pigments, organic compounds, photochromic compounds, photochromic compounds cross linked with various polymers, photochromic compounds encapsulated in polymers and thermally stable near infrared fluorophoric compounds copolymerized with an ester linkage.

It is to be appreciated that the particular light-sensitive compound or compounds applied to the product or product package may be selected based upon the light emitted from a standard optical scanner. In this regard, a particular light-sensitive compound or compounds may be used when printing the bar code on a product package or label that is capable of being scanned by a conventional scanner used at check-out counters at retail stores, for example. These scanners therefore can not only can read product information from the bar code, as is typically performed, but also can scan the product or product package for authenticity or other desired information generated by the light emission or absorption from the light-sensitive compound or compounds. Consequently, the verification device could be a scanner having properties similar to a conventional scanner used at check-out counters at retail stores.

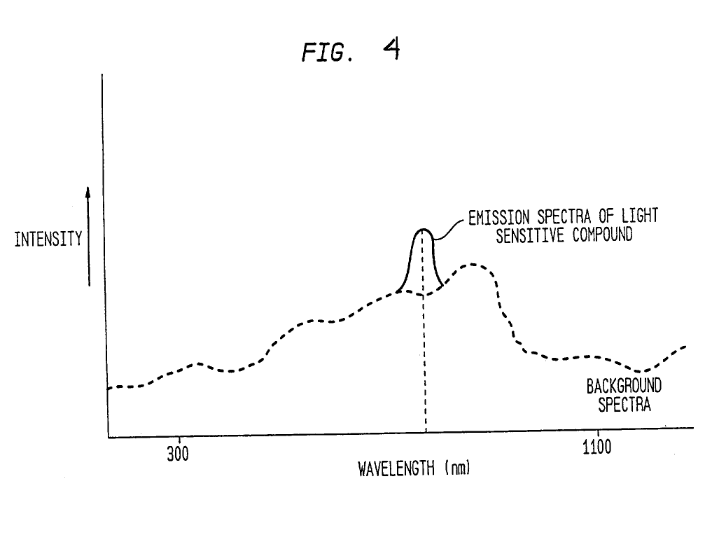

FIG. 4 illustrates an example of a background spectra that may be detected after a substrate is irradiated with light of a specific wavelength that is being proposed as an excitation wavelength for use with the invention. Once the background spectra has been determined, appropriate light-sensitive compounds may be chosen by selecting those that emit primarily at wavelengths that will not correspond directly with the peaks presented in the background spectra. Preferably, the light-sensitive candidates are chosen so that their peak emission wavelengths do not correspond with a peak in the background spectra and, most preferably, the candidates are chosen so that their spectra are easily resolvable from the background spectra.

After a group of candidate light-sensitive compounds has been chosen, the compounds may be applied to the substrate being tested, and the substrate may again be illuminated at the proposed excitation wavelength. As interactions between the light-sensitive compounds and the ink, or between the light-sensitive compounds and the substrate, may result in a shift in the wavelength that is emitted by the light-sensitive compounds, the selection of these compounds may be further refined after completion of the analysis with the candidate compounds having been applied to the substrate at appropriate concentrations.

Light-sensitive compounds of the present invention may be water dissipatable polyesters and amides such as the compounds disclosed in U.S. Pat. Nos.: 5,292,855, 5,336,714, 5,614,008 and 5,665,151, each of which is hereby incorporated by reference herein.

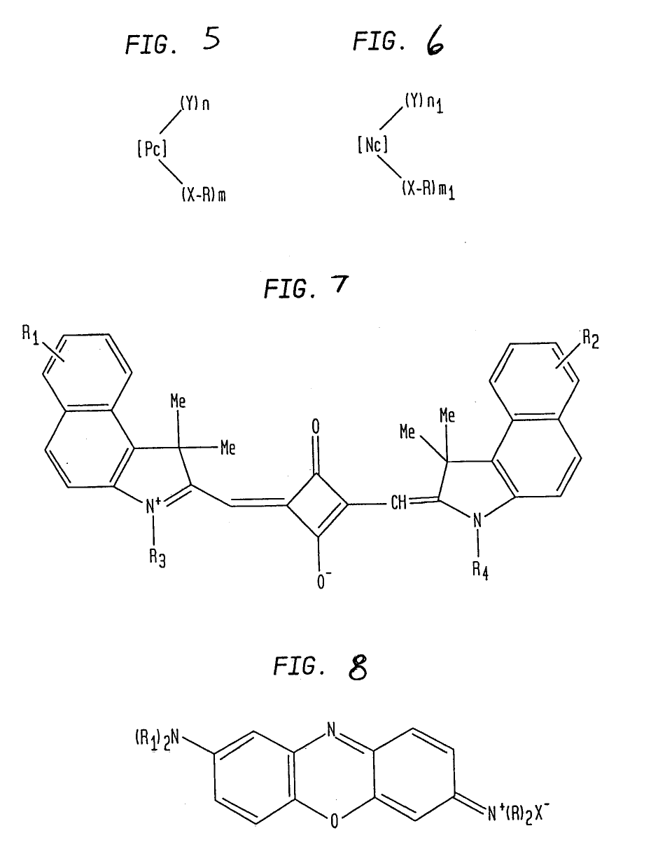

In one embodiment, the near infrared fluorescent compounds are selected from the phthalocyanines, the naphthalocyanines and the squarines (derivatives of squaric acid) that correspond respectively to the structures shown in FIGS. 5, 6 and 7. In these structures, Pc and Nc represent the phthalocyanines and naphthalocyanine moieties, covalently bonded to hydrogen or to the various metals, halometals, organometallic groups and oxymetals including AlCl, AlBr, AlF, AlOH, AlOR₅, AlSR₅, Ca, Co, CrF, Fe, Ge, Ge(OR₆), Ga, InCl, Mg, Mn, Ni, Pb, Pt, Pd, SiCl₂, SiF₂, SnCl₂, Sn(OR₆)₂, Si(OR₆)₂, Sn(SR₆)₂, Si(SR₆)₂, Sn, TiO, VO or Zn, where R₅ and R₆ are hydrogen, alkyl, aryl, heteroaryl, lower alkanoyl, or trifluoroacetyl groups.

X is oxygen, sulfur, selenium or tellurium. Y is alkyl, aryl, halogen or hydrogen and R is an unsubstituted or substituted alkyl, alkenyl, alkynyl.

—(X—R)m is alkylsulfonylamino, arylsulfonylamino, R₁ and R₂ are each independently selected from hydrogen, lower alkyl, lower alkoxy, halogen aryloxy, lower alkylthio, lower alkylsulfonyl, R₃ and R₄ are each independently selected from hydrogen, lower alkyl, alkenyl or aryl; n is an integer from 0-12; n₁ is an integer from 0-24, m is an integer from 4-16; m₁ is an integer from 0-16, provided that the sums of the n+m and n₁+m₁ are 16 and 24 respectively.

In the compounds above, the structures may include at least one polyester reactive group to allow the compound to be incorporated into a polymeric composition and to be bound by covalent bonds.

The light-sensitive compounds of the invention may also include photochromic compound such as photochromic compound incorporated into a polymeric composition and photochromic compounds encapsulated to form microcapsules as described in U.S. Pat. No. 5,807,625, which is hereby incorporated by reference.

In one embodiment, these photochromic compounds are from three classes:

(i) Spiro-indolino-naphthoxazines.

(ii) Fulgides which are derivatives of bis-methylene succinic anhydride and fulgimides which are derivatives of bis-methylene succinic imide where the imide nitrogen may be substituted by alkyl, aryl or aralkyl.

(iii) Spiro(1,8a)-dihydroindolizines.

The light-sensitive compounds of the invention may also include microbeads labeled with organic/inorganic compounds as described in U.S. Pat. No. 5,450,190, which is hereby incorporated by reference.

Also useful as light-sensitive compounds with the present invention are the compounds or compound combinations described in U.S. Pat. No. 5,286,286, which is hereby incorporated by reference. These may include:

5,10,15,20-tetrakis-(1-methyl-4-pyridyl)-21H,23H-prophine tetra-p-tosylate salt;

5,10,15,20-tetrakis-(-1-methyl-4-pyridyl)-21H,23H-porphine tetrachloride salt;

5,10,15,20-tetrakis-(1-methyl-4-pyridyl)-21H,23H-porphine tetrabromide salt;

5,10,15,20-tetrakis-(1-methyl-4-pyridyl)-21H,23H-porphine tetra-acetate salt;

5,10,15,20-tetrakis-(1-methyl-4-pyridyl)-21H,23H-porphine tetra-perchlorate salt;

5,10,15,20-tetrakis-(1-methyl-4-pyridyl)-21H,23H-porphine tetrafluoroborate salt;

5,10,15,20-tetrakis-(1-methyl-4-pyridyl)-21H,23H-porphine tetra-perchlorate salt;

5,10,15,20-tetrakis-(1-methyl-4-pyridyl)-21H,23H-porphine tetrafluoroborate salt;

5,10,15,20-tetrakis-(1-methyl-4-pyridyl)-21H,23H-porphine tetra-perchlorate salt;

5,10,15,20-tetrakis-(1-methyl-4-pyridyl)-21H,23H-porphine tetra-triflate salt;

5,10,15,20-tetrakis-(1-hydroxymethyl-4-pyridyl)-21H,23H-porphine tetra-p-tosylate salt;

5,10,15,20-tetrakis-[1-(2-hydroxyethyl)-4-pyridyl]-21H,23H-porphine tetrachloride salt;

5,10,15,20-tetrakis-[1-(3-hydroxypropyl)-4-pyridyl]-21H,23H-porphine tetra-p-tosylate salt;

5,10,15,20-tetrakis-[1-(2-hydroxypropyl)-4-pyridyl]-21H,23H-porphine tetra-p-tosylate salt;

5,10,15,20-tetrakis-[1-(-hydroxyethoxyethyl)-4-pyridyl]-21H,23H-porphine tetra-p-tosylate salt;

5,10,15,20-tetrakis-[1(2-hydroxyethoxypropyl)-4-pyridyl]-21H,23H-porphine tetra-p-tosylate salt;

5,10,15,20-tetrakis-[4-(trimethylammonio)phenyl]-21H,23H-porphine tetra-p-tosylate salt;

5,10,15,20-tetrakis-[4-(trimethylammonio)phenyl]-21H,23H-porphine tetrachloride salt;

5,10,15,20-tetrakis-[4-(trimethylammonio)phenyl]-21H,23H-porphine tetrabromide salt;

5,10,15,20-tetrakis-[4-(trimethylammonio)phenyl]-21H,23H-porphine tetra-acetate salt;

5,10,15,20-tetrakis-[4-(trimethylammonio)phenyl]-21H,23H-porphine tetra-perchlorate salt;

5,10,15,20-tetrakis-[4-(trimethylammonio)phenyl]-21H,23H-porphine tetrafluoroborate salt;

5,10,15,20-tetrakis-[4-(trimethylammonio)phenyl]-21H,23H-porphine tetra-triflate salt;

meso-(N-methyl-X-pyridinium)ₙ(phenyl)4-n-21H,23H-porphine tetra-p-tosylate salt, where n is an integer of value 0,1,2, or 3, and where X=4-(para), 3-(meta), or 2-(ortho) and refers to the position of the nitrogen in the pyridinium substituent, prepared as described, for example, by M. A. Sari et al. in Biochemistry, 1990, 29, 4205 to 4215;

meso-tetrakis-[o-(N-methylnicotinamido)phenyl]-21H,23H-porphine tetra-methyl sulfonate salt, prepared as described, for example, by G. M. Miskelly et al. in Inorganic Chemistry, 1988, 27, 3773 to 3781;

5,10,15,20-tetrakis-(2-sulfonatoethyl-4-pyridyl)-21H,-23H-porphine chloride salt, prepared as described by S. Igarashi and T. Yotsuyanagi in Chemistry Letters, 1984, 1871;

5,10,15,20-tetrakis-(carboxymethyl-4-pyridyl)-21H,23H-porphine chloride salt

5,10,15,20-tetrakis-(carboxyethyl-4-pyridyl)-21H,23H-porphine chloride salt

5,10,15,20-tetrakis-(carboxyethyl-4-pyridyl)-21H,23H-porphine bromide salt

5,10,15,20-tetrakis-(carboxylate-4-pyridyl)-21H,23H-porphine bromide salt, prepared as described by D. P. Arnold in Australian Journal of Chemistry, 1989, 42, 2265 to 2274;

2,3,7,8,12,13,17,18-octa-(2-hydroxyethyl)-21H-23H-porphine;

2,3,7,8,12,13,17,18-octa-(2-hydroxyethoxyethyl)-21H-23H-porphine;

2,3,7,8,12,13,17,18-octa(2-aminoethyl)-21H-23H-porphine;

2,3,7,8,12,13,17,18-octa-(2-hydroxyethoxypropyl)-21H-23H-porphine, and the like, as well as mixtures thereof.

Also suitable for use with the present invention are dansyl compounds, including: dansyl-L-alanine; a-dansyl-L-arginine; dansyl-L-asparagine; dansyl-L-aspartic acid; dansyl-L-cysteic acid; N,N′-di-dansyl-L-cystine; dansyl-L-glutamic acid; dansyl-L-glutamine; N-dansyl-trans-4-hydroxy-L-proline; dansyl-L-isoleucine; dansyl-L-leucine; di-dansyl-L-lysine; N-ε-dansyl-L-lysine; dansyl-L-methionine; dansyl-L-norvaline; dansyl-L-phenylalanine; dansyl-L-proline; N-dansyl-L-serine; N-dansyl-L-threonine; N-dansyl-L-tryptophan; O-di-dansyl-L-tyrosine monocyclohexylammonium salt; dansyl-L-valine; dansyl-γ-amino-n-butyric acid; dansyl-DL-a-amino-n-butyric acid; dansyl-DL-aspartic acid; dansyl-DL-glutamic acid; dansylglycine; dansyl-DL-leucine; dansyl-DL-methionine; dansyl-DL-norleucine; dansyl-DL-norvaline; dansyl-DL-phenylalanine; dansylsarcosine N-dansyl-DL-serine; N-dansyl-DL-threonine; N-α-dansyl-DL-tryptophan; dansyl-DL-valine dansyl-DL-α-aminocaprylic acid cyclohexylamine salt; (dansylaminoethyl)trimethylammonium perchlorate; didansylcadaverine; monodansylcadaverine; dansylputrescine; dansylspermidine; didansyl-1,4-diaminobutane; didansyl-1,3-diamino-propane; didansylhistamine, all available from Sigma Chemical Corp., St. Louis, Mo., and the like, as well as mixtures thereof.

Additional light-sensitive compounds may also include an organic/inorganic pigment as described in U.S. Pat. No. 5,367,005 or any compound or compound combination of phenoxazine derivatives as described in U.S. Pat. No. 4,540,595, which is hereby incorporated by reference.

The general chemical formula of the phenoxazine compounds is shown in FIG. 8 in which R₁ and R₂ are alkyl groups and X⁻ is an anion.

Additional light-sensitive compounds of the present invention may be classified in one of the following four groups depending upon excitation and emission regions, as described in U.S. Pat. No. 4,598,205, which is hereby incorporated by reference.

(a) Excitation UV-Emission UV

(b) Excitation UV-Emission IR

(c) Excitation IR-Emission UV

(d) Excitation IR-Emission IR

Also useful with the present invention is any compound or compound combination of organic infrared fluorescing compound that is soluble in the ink vehicle disclosed in U.S. Pat. No. 5,093,147, which is hereby incorporated by reference. Such light-sensitive compounds include: (3,3′-Diethylthiatricarbocyanine Iodide); (3,3′-Diethyl-9,11-neopentylenethiatricarbocyanine Iodide); (1,1′,3,3,3′,3′-Hexamethyl-4,4′,5,5′-dibenzo-2,2′-indotricarbocyanine Iodide); (Hexadibenzocyanine 3); 1H-Benz[e]indolium, 2-[7-[1,3-dihydro-1,1-dimethyl-3-(4-sulfobutyl)-2H-benz[e]indol-2-ylidene]-1,3,5-hepatrienyl]-1,1-dimethyl-3-(4-sulfobutyl-, sodium salt; (3,3′-Diethyl-4,4′,5,5′-dibenzothiatricarbocyanine Iodide)(Hexadibenzocyanine 45); Benzothiazolium, 5-chloro-2[2-[3-[5-chloro-3-ethyl-2(3H)-benzothiazolylidene-ethylidene]-2-(diphenylamino)-1-cyclopenten-1-yl]ethyl]-3-ethyl-, perchlorate; (1,1′-Diethyl-4,4′-dicarbocyanine Iodide); Naphtho[2,3-d]thiazolium, 2-[2-[2-(diphenylamino)-3-[[3-(4-methoxy-4-oxobutyl)naptho[d]thiazol-2(3H)-ylidene-ethylidene]-1-cyclopenten-1-yl]ethenyl]3-(4-methoxy-oxobutyl)-, perchlorate

The following light-sensitive compounds may also be useful with the present invention: Sulfuric acid disodium salt mixture with 7-(diethylamino)-4-methyl-2H-1-benzopyran-2-one; 3′,6′-bis(diethylamino)-spiro-(isobenzofuran-1(3H),9′-(9H)xanthen)-3-one or 3′,6′-bis(diethyl-amino)-fluoran; 4-amino-N-2,4-xylyl-naphthalimide; 7-(diethylamino)-4-methyl-coumarin; 14H-anthra[2,1,9-mna]thioxanthen-14-one; N-butyl-4-(butylamino)-naphthalimide.

In addition, the following compounds may also be used as light-sensitive compounds with the present invention: 5-(2-Carbohydrizinomethyl thioacetyl)-aminofluorescein; 5-(4,6-dichlorotriazinyl)-aminofluorescein; Fluor-3-pentammonium salt; 3,6-diaminoacridine hemisulfate, proflavine hemisulfate; Tetra(tetramethylammonium salt; Acridine orange; BTC-5N; Fluoresceinamine Isomer I; Fluoresceinamine Isomer II; Sulfite blue; Coumarin diacid cryptand[2,2,2]; Eosin Y; Lucifier yellow CH Potassium salt; Fluorescein isothiocyanate (Isomer I); Fluorescein isothiocyanate (Isomer II); Fura-Red, AM; Fluo-3 AM; Mito Tracker Green FM; Rhodamine; 5-carboxyfluorescein; Dextran Fluroscein; Merocyanine 540; bis-(1,3-diethylthiobarbituric acid trimethine oxonol; Fluorescent brightner 28; Fluorescein sodium salt; Pyrromethene 556; Pyrromethene 567; Pyrromethene 580; Pyrromethene 597; Pyrromethene 650; Pyrromethene 546; BODIPY 500/515; Nile Red; Cholesteryl BODIPY FL C12; B-BODIPY FL C12-HPC; BODIPY Type D-3835; BODIPY 500/510 C5-HPC; IR-27 Aldrich 40,610-4; IR-140 Aldrich 26,093-2; IR-768 perchlorate Aldrich 42,745-4; IR-780 Iodide Aldrich 42,531-1; IR-780 perchlorate Aldrich 42-530-3; IR-786 Iodide Aldrich 42,413-7; IR-786 perchlorate Aldrich 40,711-9; IR-792 perchlorate Aldrich 42,598-2; 5-(and-6)-carboxyfluorescein diacetate; 6-caroxyfluorescein Sigma; Fluorescein diacetate; 5-carboxyfluorescein diacetate; Fluorescein dilaurate; Fluorescein Di-b-D-Galactopyranoside; FluoresceinDi-p-Guanidinobenzoate; Indo I-AM; 6-caroxyfluorescein Diacetate; Fluorescein thiosemicarbazide; Fluorescein mercuric acetate; Alcian Blue; Bismarck Brown R; Copper Phthalocyanine; Cresyl Violet Acetate; Indocyanine Green; Methylene Blue; Methyl Green, Zinc chloride salt Sigma; Oil Red 0; Phenol Red Sigma; Rosolic Acid; Procion Brilliant Red; Ponta Chrome Violet SW; Janus Green Sigma; Toluidine Blue Sigma; Orange G; Opaque Red; Mercuric Oxide Yellow; Basic Fuchsin; Flazo Orange; Procion Brilliant Orange; 5-(and-6)-carboxy-2′,7′-dichlorofluorescein; 5-(and-6)-carboxy-4′,5′-dimethyl fluorescein; 5-(and-6)-carboxy-2′,7′-dichlorofluorescein diacetate; Eosin-5-maleimide; Eosin-5-Iodoacetamide; Eosin Isothiocyanate; 5-Carboxy-2′,4′,5′,7′-tetrabromosulfonefluorescein; Eosin thiosemicarbazide; Eosin Isothiocyanate Dextran 70S; 5-((((2-aminoethyl)thio)acetyl)amino) fluorescein; 5-((5-aminopentyl)thioureidyl)fluorescein; 6-carboxyfluorescein succinimidyl ester; 5,5′-dithiobis-(2-nitrobenzoic acid); 5-(and-6)-carboxyfluorescein succinimidyl ester; Fluorescein-5-EX, succinimidyl ester; 5-(and-6-)-carboxy SNARF-1; Fura Red, Tetrapotassium salt; Dextran fluorescien, MW 70000; 5-(and-6-)-carboxynaphthafluorescein mixed isomers; Rhodol green, carboxylic acid succinimdyl ester; 5-(and-6-)-carboxynaphthafluorescein SE mixed isomers; 5-carboxyfluorescein, SE single isomer; 5-(and-6)-carboxy-2′,7′-dichlorofluorescein diacetate, SE; 5-(and-6)-carboxy-SNAFL-1, SE; 6-tetramethylrhodamine-5- and -6-carboxamido hexanoic acid, SE; Styryl Compound (4-Di-1-ASP); Erythrosin-5-isothiocyanate; Newport green, dipotassium salt; Phen green, dipotassium salt; Bis-(1,3-dibutylbarbitlric acid0 trimethine oxonol; lucigenin(bis-N-methyl acridinium nitrate, tetrakis-(4-sulfophenyl) porphine; tetrakis-(4-carboxyphenyl) porphine; anthracene-2,3-dicarboxaldehyde, 5-((5-aminopentyl)thioureidyl) eosin, hydrochloride, N-(ethoxycarbonylmethyl)-6-methoxyquinolinium brimide; MitoFluor green; 5-aminoeosin, 4′(aminomethyl)fluorescein; hydrochloride; 5′(aminomethyl)fluorescein, hydrochloride; 5-(aminoacetamido)fluorescein; 4′((aminoacetamido) methyl) fluorescein; 5-((2-(and-3)-S-(acetylmercapto)succinoyl)amino fluorescein; 8-bromomethyl-4,4-difluoro-1,3,5,7-tetramethyl-4-bora-3a,4a,diaza-s-indacene; 5-(and-6)-carboxy eosin; cocchicine fluorescein; Casein fluorescein, 3,3′-dipentyloxacarbocyanine iodide; 3,3′-dihexyloxacarbocyanine iodide; 3,3′-diheptyloxacarbocyanine iodide; 2′-7′-difluorofluorescein; BODIPY FL AEBSF; fluorescein-5-maleimide; 5-iodoacetamidofluorescein; 6-iodoacetamidofluorescein; Lysotracker green; Rhodamine 110; Arsenazo I; Aresenazo III sodium; Bismarck brown Y; Brilliiant Blue G; Carmine; b-carotene; Chlorophenol red; Azure A; Basic fuchsin; di-2-ANEPEQ; di-8-ANEPPQ; di-4-ANEPPS; and di-8-ANEPPS where ANEP(aminonaphthylethenylpyridinium).

The spectral properties, such as wavelength or light emission, of the ink may change as a result of interactions between the light-sensitive compound and the ink. That is, the spectral properties of the light-sensitive compound may be different when in the presence of the ink. Thus, when tuning or formatting the probe assembly with appropriate light source(s) and filters, this interaction should be taken into account, so that the probe assembly is capable of detecting the desired light response.

Similarly, the light response may change as a result of interactions between the ink with the light-sensitive compound mixed therein and the product packaging itself or any background printing on the product packaging. Further, the light response may change as a result of heating of the light-sensitive compound (with or without ink) as it is printed using an ink jet printer. Here again, these changes should be taken into account when tuning or formatting the probe assembly with appropriate light source(s) and filters.

Further, the light response may change as a result of interactions between the resulting mark (i.e., compound and ink, if used) and the sealer (if used). Such changes should also be taken into account when tuning or formatting the optical detector.

In one embodiment, to operate the system, various switches (not shown) may be turned on to supply power to the printer, controller and verification device. Prior to verifying the product or product package, the verification device may self-calibrate by detecting the amount of background light surrounding the detector. To accomplish this, for example, the device compares the spectral properties of light received when the light source is off and when it is on. The mark on the product or product package to be verified may then be irradiated with an irradiating wavelength of light emitting from the light source. The light may then be filtered using the source filter to obtain desired wavelengths of light and focused by the lens onto the mark.

In one example of using a light-sensitive compound, the irradiated light-sensitive compound in the mark emits a predetermined wavelength of light, based on the wavelengths of light being emitted from the light source as well as the particular light-sensitive compounds used in the mark. Change in spectral properties (e.g., light response), such as light emission, due to the presence of light-sensitive compounds in the mark can be determined from the formula [(Fd−Fp)/Fd]×100, where the light emission of the mark in the absence of light-sensitive compound is Fp, and the light emission of the mark with the light-sensitive compound is Fd. The light emission changes as a result of interactions of the light-sensitive compound with ink, if used. The emission filters then filter undesired wavelengths of light emitting from the sample mark such that, for example, only peak wavelengths of light are passed through. The light is then directed to the optical detector, which then generates a voltage level indicative of the amount of light emitted from the mark. The device then converts the signal into a sample characteristic, which is then compared with a fingerprint to verify the presence and correctness of the mark. In one embodiment, an authentic mark is indicated when the value of the detected sample characteristic is within 10% of the value of the fingerprint. The device may then indicate whether the mark is authentic and has been correctly applied using any suitable indicating method, such as those described above.

It is to be appreciated that the intensity or quantity of light emission from the sample mark is detected. However, according to one aspect of the present invention, intensity decay or a change in the quantity of light emission over time may be used to provide the sample characteristic. Alternatively, any such combination may be used to provide the sample characteristic. As used herein, the term “light emission” means intensity or quantity or intensity decay or change in quantity of light emitted from the sample mark.

Rather than, or in addition to, comparing certain spectral properties such as light emission or absorption from the light-sensitive compound to a stored fingerprint, in some instances it may be desirable to compare a ratio of light emission or absorption of two different wavelengths of light to a stored ratio fingerprint. In one embodiment, this may be accomplished by providing a light-sensitive compound that is capable of emitting two different peak wavelengths of light or, alternatively, providing two or more different light-sensitive compounds, each producing a characteristic peak wavelength having a certain light emission. By using a ratiometric approach at two or more different wavelengths, it may be possible to verify the correct application of a mark without requiring background compensation. A ratiometric analysis may allow the device to simply measure the intensity at each of the wavelengths and ratio these two values without requiring that the spectra be resolved to baseline. This may allow the detector to simply ignore any background rather than account for it. If two or more light-sensitive compounds are used, each may be printed in one or more locations on the package, product, label or container.

In addition to using compounds that may emit at specific wavelengths in response to an excitation light source, the present invention may also employ compounds that absorb at specific wavelengths, as briefly discussed above. For example, the substrate being analyzed may be irradiated at a specific wavelength and reflect that same wavelength back to the detector. An area on the substrate may be covered by an absorbing compound that may absorb at the wavelength of the irradiating light and therefore be detected as an area of lower emission or reflectance than the surrounding area. Two or more absorbers may be used in a way similar to that used with emitters, as described above. In addition, absorbers may be used in conjunction with emitters.

In one embodiment, two or more light-sensitive compounds with different emission wavelengths are used and may be added to ink. It should be appreciated that different light-sensitive compounds can be added to different inks. For example, a first light-sensitive compound may be added to a first ink and a second light-sensitive compound may be added to a second ink with the two inks being used to create a single mark. The light-sensitive compounds and ink, if used, are printed onto the product or packages and appear as a single detectable mark, such as a bar code or message. In one embodiment, the ink, if used, is water insoluble.

With respect to the use of light-sensitive compounds, the relative fluorescence from each light-sensitive compound may be detected. The light-sensitive compounds may be UV excitable compounds, IR excitable compounds or any combination thereof. For example, one UV excitable compound and one or more IR excitable compounds may be used. Alternatively, one IR excitable compound and one or more UV excitable compounds may be used. Also, two or more UV excitable compounds and two or more IR excitable compounds may be used. Thus, the range of emission wavelengths can range from about 300 nm to about 2400 nm.

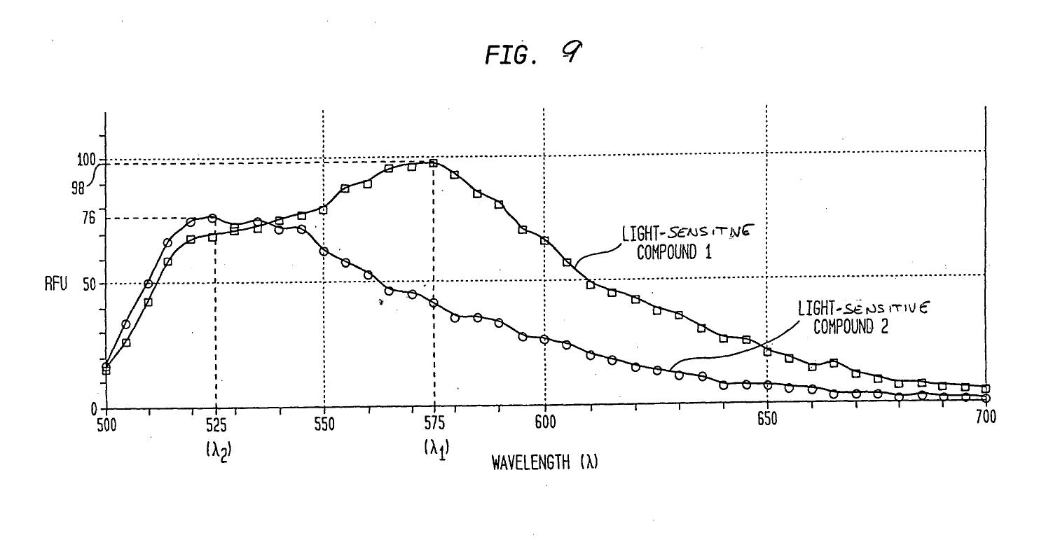

An example of such a ratio is shown in FIG. 9. Here, a ratio of the light emission for the peak wavelengths of two different light-sensitive compounds is used in a comparison with a stored standard fingerprint. For example, two light-sensitive compounds are mixed at a certain concentration with ink. An excitation wavelength of light of 485 nm is applied to the ink. Light-sensitive Compound 1 has a Relative Fluorescence Unit (RFU) of 98 at a peak wavelength (λ₁) of 575 nm and Light-sensitive Compound 2 has an RFU of 76 at a peak wavelength (λ₂) of 525 nm. The ratio of the RFU values at the peak wavelengths of 575 to 525 is approximately 1.3. This ratio of 1.3 may then be used in the comparison to the stored fingerprint ratio. Although Relative Fluorescence Units are used in this example to indicate the value of the amount of light emitted, other units may be used, such as photon count, for example.

In another embodiment, a ratio of the RFU of the excitation light may be used. Also, the ratio of any combination of the RFU of excitation light or light emitted from the light-sensitive compound may be employed. As above, the ratio may be compared to a stored fingerprint ratio. For example, two light-sensitive compounds are mixed at a certain concentration with ink. An excitation wavelength of light is applied to the mixture. The light-sensitive compound has an excitation RFU at the excitation wavelength and has an emission RFU at the emission wavelength. The ratio of the excitation RFU to the emission RFU is then compared to a stored fingerprint ratio. In another embodiment, the light-sensitive compound has two discrete excitation RFU values. The ratio of the first excitation RFU value to the second excitation RFU value is then compared to a stored fingerprint ratio. As above, although Relative Fluorescence Units are used in this example to indicate the value of the amount of light, other units may be used, such as photon count, for example. The particular ratio (i.e., excitation RFU to emission RFU, excitation RFU to excitation RFU, or emission RFU to emission RFU) may be set by the manufacturer of the device or may be user selectable.

One such instance where it may be useful to compare the ratio arises due to the interaction of the ink with the light-sensitive compounds. Generally, the solvent used in the ink may tend to evaporate in use or before printing onto the product or product package. This may cause a change in the concentration of the light-sensitive compound relative to the ink, thereby changing the excitation light or the light emission of the irradiated ink. However, if one or more light-sensitive compounds are used excitable at or emitting at at least two peak wavelengths of light (or absorbing at two valleys, as may be the case with light-absorbing compounds), then the ratio may be used because the ratio remains constant or unaffected relative to solvent levels.

Detecting such a ratio may also be preferable when the light-sensitive compounds are placed on an optical disk. This ratio may be changed during manufacture of the product, for example the optical disk, by varying blends and/or intensities of the light-sensitive compounds.

The ratiometric analysis of the present invention allows the number of fingerprint emission profiles to be greatly increased over the number of profiles that can be created simply by detecting the presence of one or more light-sensitive compounds in the mark. For instance, two specific light-sensitive compounds may be assigned to authenticate a specific product line. However, within that product line, variables such as place of origin, date of production, or place of distribution may be further defined by varying the ratio of the two light-sensitive compounds that are used in the authenticating mark. In this manner, a particular light-sensitive compound or group of light-sensitive compounds may be uniquely assigned to a specific company or product line, and the user of that combination of light-sensitive compounds can be assured that the same combination is not being used by others. Alternatively, a certain range of ratios for a specific combination of light-sensitive compounds may be assigned to a particular product line, division, or company.

In yet another situation, the use of the ratio allows the verification device to be self-calibrating for surrounding light, temperature and other conditions, in addition to the self-calibration procedure discussed above. The device may also compensate for degradation of the light source, the electronics or the optical detector, for example. While the light emission (or absorption) or detection thereof of a single wavelength of a light-sensitive compound may change due to the above noted factors, the ratio of light emission (or absorption) or excitation between two wavelengths of the light-sensitive compound remains relatively constant. Thus, during the verification process, this ratio may be used, rather than the actual value, to determine whether the mark has been applied correctly. Any variability due to a comparison of verified data with stored data is therefore removed.

It is also to be appreciated that the sampling rate may be changed such that a plurality of sample readings are taken on a specific ink sample. In a preferred embodiment, about 10,000 readings are taken. Thus, a high degree of confidence may be obtained in providing the sample characteristics. To further increase the level of confidence in verifying the presence and correctness of an authentic mark, the light emission (or absorption), the light emission (or absorption) ratio of more than one wavelength, and the particular pattern of the authenticating mark, if printed as other than the bar code, having a very high number of data points, may each be compared to the standard fingerprint.

Preferably, the target substrate is illuminated at the excitation wavelength for a short duration. This allows for an adequate level of excitation of the compounds while minimizing external effects such as the effect that a bright flash may have those in the area where the analysis is taking place. For example, the substrate is illuminated at the excitation frequency for less than about a millisecond.

With such a large amount of data generated, although possible, conventional data analysis comparing one or two variables at a given time, is not practical. Thus, according to one aspect of the invention, multivariable analysis or multivariable pattern recognition may be used. In a preferred embodiment, Tukey's analysis and Principle Component Analysis (PCA) are used. Other multivariable techniques that may be utilized include Hierarchical Cluster Analysis, K Nearest Neighbor, Pineapple Component Regression, Partial Least Squares Regression, and Soft Independent Modeling of Class Analogy (SIMCA). These multivariable techniques reduce the dimensionality of the data to two or three dimensions, allowing for patterns or relationships to be generated. These generated patterns may then be compared to digitally-captured plate images. It is to be appreciated that the patterns may include both structure and color.

Analysis of the data may also be performed by developing plots having distinct clusters summarizing the similarity and differences among the samples being analyzed to a stored standard. Such analysis may be performed in addition to or in the alternative to the above mentioned multivariable or multivariable pattern recognition.

Having thus described certain embodiments of the present invention, various alterations, modification and improvements will readily occur to those skilled in the art. Such alterations, modifications, and improvements are intended to be within the spirit and scope of the invention. Accordingly, the foregoing description is by way of example only, and not intended to be limiting. The invention is limited only as defined in the following claims and the equivalent thereof.

What is claimed is:

1. A system for applying at least a portion of an authentication mark to a substrate and verifying the application of at least a portion of the mark on the substrate, the substrate being disposed on a production line, the system comprising:
an applicator locatable at the production line and configured and arranged to apply at least one light-sensitive compound on the substrate to produce at least a portion of the authentication mark; and
a verification device locatable at the production line and configured and arranged to verify application of the at least one light-sensitive compound on the substrate.

2. The system according to claim 1, wherein the applicator is a continuous ink jet printer.

3. The system according to claim 1, wherein the applicator is a printer that prints an ink mixed with the at least one light-sensitive compound.

4. The system according to claim 3, wherein the ink is a water-insoluble ink.

5. The system according to claim 3, wherein the verification device verifies whether a correct light-sensitive compound has been applied.

6. The system according to claim 1, wherein the verification device verifies whether a correct light-sensitive compound has been applied.

7. The system according to claim 3 wherein the verification device irradiates at least the at least one light-sensitive compound with light and detects a first light response of the at least one light-sensitive compound.

8. The system according to claim 7, wherein the first light response is compared with a fingerprint.

9. The system according to claim 8, wherein the printer produces at least the portion of the mark by printing a first ink mixed with a first light-sensitive compound and a second ink mixed with a second light-sensitive compound with a second ink.

10. The system according to claim 9 wherein the first and second inks are the same ink.

11. The system according to claim 9, wherein the verification device detects a second light response.

12. The system according to claim 11, wherein the second light response is compared with the fingerprint.

13. The system according to claim 11, wherein the second light response is different from the first light response.

14. The system according to claim 11, wherein the verification device determines a ratio of the first and second responses and compares the ratio to a fingerprint.

15. The system according to claim 1, wherein the printer prints the at least one light-sensitive compound mixed with a solvent.

16. The system according to claim 1, in combination with the substrate.

17. The combination according to claim 16, wherein the substrate is a product or a product package.

18. The system according to claim 1, in combination with the production line.

19. The combination according to claim 18, wherein the applicator is placed at the production line.

20. The combination according to claim 18, wherein the verification device is placed at the production line.

21. The combination according to claim 18, wherein the verification device and the applicator are placed at the production line and wherein the verification device is placed downline of the applicator.

22. The system according to claim 1, further comprising a controller communicating with both the applicator and the verification device.

23. The system according to claim 1, further comprising an indicator coupled to the verification device and adapted to indicate the verification of at least the portion of the mark.

24. The system according to claim 1, further comprising a controller communicating with the verification device and a production line controller.

25. A method of applying at least a portion of an authentication mark to a substrate and verifying the application of at least the portion of the mark, the substrate being disposed on a production line, the method comprising:
applying at least one light-sensitive compound on the substrate to produce at least the portion of the authentication mark, the application occurring as the substrate proceeds through the production line; and
verifying application of the at least one light-sensitive compound on the substrate as the substrate proceeds through the production line.

26. The method according to claim 25, wherein verifying application of the at least one light-sensitive compound comprises detecting a light response from the at least one light-sensitive compound as the substrate proceeds through the production line.

27. The method according to claim 26, further comprising packaging the substrate after the substrate has been verified as having a correct mark.

28. The method according to claim 27, further comprising shipping the substrate.

29. The method according to claim 25, wherein applying at least one light-sensitive compound to produce the mark comprises mixing a first light-sensitive compound with a first ink.

30. The method according to claim 29, wherein verifying the application of the at least one light-sensitive compound comprises irradiating the at least one light-sensitive compound with light and detecting a first light response.

31. The method according to claim 30, wherein the first light response is compared with a fingerprint.

32. The method according to claim 31, wherein applying at least one light-sensitive compound to produce at least the portion of the mark comprises mixing a first light-sensitive compound with a first ink and a second light-sensitive compound with a second ink.

33. The method according to claim 32, wherein the first and second inks are the same ink.

34. The method according to claim 32, wherein verifying the application of the at least one light-sensitive compound comprises detecting a second light response from the second light-sensitive compound.

35. The method according to claim 34, wherein the second light response is compared with a fingerprint.

36. The method according to claim 34, wherein the second light response is different from the first light response.

37. The method according to claim 34, further comprising obtaining a ratio of the first and second light responses and comparing the ratio to a fingerprint.

38. The method according to claim 25, wherein applying at least a portion of the mark comprises mixing the at least one light-sensitive compound with a solvent.

39. The method according to claim 25, wherein applying at least a portion of the mark as the substrate proceeds through the production line comprises stopping the substrate during application.

40. The method according to claim 25, wherein applying at least a portion of the mark as the substrate proceeds through the production line comprises applying at least a portion of the mark as the substrate moves along the production line.

41. The method according to claim 25, wherein verifying application of the at least one light-sensitive compound as the substrate proceeds through the production line comprises stopping the substrate during verifying.

42. The method according to claim 25, wherein verifying application of the at least one light-sensitive compound as the substrate proceeds through the production line comprises verifying as the substrate moves along the production line.

43. The system according to claim 1, wherein the verification device comprises:
a frame;
a light source mounted to the frame, the light source adapted to emit light having a predetermined wavelength to irradiate the at least one light-sensitive compound and the substrate; and
an excitation filter mounted to the frame and cooperating with the light source to filter an undesired wavelength of light emitting from the light source;
wherein the frame and at least one of the light source and the excitation filter are constructed and arranged such that at least one of the light source and the excitation filter is removable from the frame by a user thereby allowing the user to employ at least one of a different light source capable of emitting light having a different predetermined wavelength of light and a different excitation filter capable of filtering a different undesired wavelength of light emitting from the light source.

44. The system according to claim 43, wherein the verification device further comprises an emission filter mounted to the frame and adapted to filter an undesired wavelength of light emitting from at least one of the substrate, the at least one light-sensitive compound and ambient light;
wherein the frame and the emission filter are constructed and arranged such that the emission filter is removable from the frame by a user thereby allowing the user to employ a different emission filter capable of filtering a different undesired wavelength of light emitting from at least one of the substrate, the least one light-sensitive compound and the ambient light.

45. The system according to claim 43, wherein the verification device further comprises a detector mounted to the frame and adapted to detect light response from the at least one light-sensitive compound.

46. The system according to claim 43, wherein the verification device further comprises an excitation lens mounted to the frame and adapted to focus light emitting from the light source.

47. The system according to claim 46, wherein the frame and the excitation lens are constructed and arranged such that the excitation lens is removable from the frame by a user thereby allowing the user to employ a different excitation lens.

48. The system according to claim 44, wherein the verification device further comprises an emission lens mounted to the frame and adapted to focus light emitting from at least one of the substrate, the least one light-sensitive compound and the ambient light.

49. The system according to claim 48, wherein the frame and the emission lens are constructed and arranged such that the emission lens is removable from the frame by a user thereby allowing the user to employ a different emission lens.

50. A system for applying at least a portion of an authentication mark to a substrate and verifying the application of at least the portion the mark on the substrate, the substrate being disposed on a production line, the system comprising:
a printer locatable at the production line and configured and arranged to print at least one light-sensitive compound on the substrate to produce the at least the portion of the authentication mark; and
a verification device locatable at the production line and configured and arranged to verify application of the at least one light-sensitive compound on the substrate, wherein the verification device comprises:
a frame;
a light source mounted to the frame, the light source adapted to emit light having a predetermined wavelength to irradiate the at least one light-sensitive compound and the substrate; and
an excitation filter mounted to the frame and cooperating with the light source to filter an undesired wavelength of light emitting from the light source;
wherein the frame and at least one of the light source and the excitation filter are constructed and arranged such that at least one of the light source and the excitation filter is removable from the frame by a user thereby allowing the user to employ at least one of a different light source capable of emitting light having a different predetermined wavelength of light and a different excitation filter capable of filtering a different undesired wavelength of light emitting from the light source;
a detector adapted to detect at least a first light response from the at least one light-sensitive compound; and
a controller for comparing at least the first light response to a fingerprint.

51. The system according to claim 50, wherein the detector is adapted to detect a second light response.

52. The system according to claim 51, wherein the controller determines a ratio of the first and second light responses and compares the ratio to a fingerprint.

53. The system according to claim 50, in combination with the production line.

54. The combination according to claim 53, wherein the printer is placed at the production line.

55. The combination according to claim 53, wherein the verification device is placed at the production line.

56. The combination according to claim 53, wherein the verification device and the printer are placed at the production line and wherein the verification device is placed downline of the printer.

57. The system according to claim 50, wherein the verification device further comprises an emission filter mounted to the frame and adapted to filter an undesired wavelength of light emitting from at least one of the substrate, the at least one light-sensitive compound and ambient light;
wherein the frame and the emission filter are constructed and arranged such that the emission filter is removable from the frame by a user thereby allowing the user to employ a different emission filter capable of filtering a different undesired wavelength of light emitting from at least one of the substrate, the least one light-sensitive compound and the ambient light.

58. The system according to claim 50, wherein the verification device further comprises an excitation lens mounted to the frame and adapted to focus light emitting from the light source.

59. The system according to claim 58, wherein the frame and the excitation lens are constructed and arranged such that the excitation lens is removable from the frame by a user thereby allowing the user to employ a different excitation lens.

60. The system according to claim 57, wherein the verification device further comprises an emission lens mounted to the frame and adapted to focus light emitting from at least one of the substrate, the least one light-sensitive compound and the ambient light.

61. The system according to claim 60, wherein the frame and the emission lens are constructed and arranged such that the emission lens is removable from the frame by a user thereby allowing the user to employ a different emission lens.
